(19) United States
(12) Patent Application Publication
(10) Pub. No.: US 2026/0044382 A1
(43) Pub. Date: Feb. 12, 2026

(54) Wireless Network Device with Multiple Processing Chains

(71) Applicant: Dell Products L.P., Round Rock, TX (US)

(72) Inventors: Yongxia Lyu, Ottawa (CA); Satish Venkob, Mississauga (CA); Morris Repeta, Ottawa (CA)

(21) Appl. No.: 18/796,185

(22) Filed: Aug. 6, 2024

(51) Int. Cl. G06F 9/50; G06F 9/455

(52) U.S. Cl. CPC G06F 9/5044; G06F 9/455; G06F 9/5038; G06F 9/5055

(57) ABSTRACT

A system can comprise a first processing path through a radio access unit of the system, wherein the system is configured to conduct wireless communications with user equipment. The system can comprise a second processing path through the radio access unit, wherein a first amount of time associated with processing via the first processing path is less than a second amount of time associated with processing via the second processing path. The system can, based on identifying data to process, select the first processing path as a selected processing path, or select the second processing path as the selected processing path. The system can process the data with the selected processing path, to produce processed data. The system can communicate the processed data with the user equipment as part of the wireless communications.

### BACKGROUND

Wireless communication networks can facilitate network communications with devices. In some examples, a wireless communications network can comprise a broadband cellular network, where a base station communicates with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can comprise a first processing path through a radio access unit of the system, wherein the system is configured to conduct wireless communications with user equipment. The system can comprise a second processing path through the radio access unit, wherein a first amount of time associated with processing via the first processing path is less than a second amount of time associated with processing via the second processing path. The system can, based on identifying data to process, select the first processing path as a selected processing path, or select the second processing path as the selected processing path. The system can process the data with the selected processing path, to produce processed data. The system can communicate the processed data with the user equipment as part of the wireless communications.

An example method can comprise, based on identifying a data packet to process, based on identifying a data packet to process, selecting, by a system comprising at least one processor that is configured to facilitate wireless communications with user equipment, a first processing path of a radio access unit as a selected processing path, or selecting, by the system, a second processing path of the radio access unit as the selected processing path, wherein a first amount of time associated with processing via the first processing path is less than a second amount of time associated with processing via the second processing path. The method can further comprise processing, by the system, the data packet with the selected processing path, to produce a processed data packet. The method can further comprise communicating, by the system, the processed data packet to the user equipment as part of the wireless communications.

An example non-transitory computer-readable medium can comprise instructions that, in response to execution, cause a system comprising a processor to perform operations. These operations can comprise, based on identifying data to process as part of facilitating wireless communications with user equipment, selecting a first processing path of a radio access unit as a selected processing path, or selecting a second processing path of the radio access unit as the selected processing path, wherein a first amount of time associated with processing via the first processing path is less than a second amount of time associated with processing via the second processing path. These operations can further comprise communicating processed data that corresponds to the data to the user equipment as part of the wireless communications via the selected processing path.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a wireless network device with multiple processing chains, in accordance with an embodiment of this disclosure;

FIG. 2 illustrates an example system architecture of an Open Radio Access Network (O-RAN) distributed unit (DU; O-DU) that can facilitate a wireless network device with multiple processing chains, in accordance with an embodiment of this disclosure;

FIG. 3 illustrates an example system architecture of an O-DU processing path that can facilitate a wireless network device with multiple processing chains, in accordance with an embodiment of this disclosure;

FIG. 4 illustrates another example system architecture of an O-DU processing path that can facilitate a wireless network device with multiple processing chains, in accordance with an embodiment of this disclosure;

FIG. 5 illustrates another example system architecture of an O-DU that can facilitate a wireless network device with multiple processing chains, in accordance with an embodiment of this disclosure;

FIG. 6 illustrates an example system architecture of an accelerator card that can facilitate a wireless network device with multiple processing chains, in accordance with an embodiment of this disclosure;

FIG. 7 illustrates another example system architecture of an accelerator card that can facilitate a wireless network device with multiple processing chains, in accordance with an embodiment of this disclosure;

FIG. 8 illustrates an example processing flow of an O-DU that can facilitate a wireless network device with multiple processing chains, in accordance with an embodiment of this disclosure;

FIG. 9 illustrates another example processing flow of an O-DU that can facilitate a wireless network device with multiple processing chains, in accordance with an embodiment of this disclosure;

FIG. 10 illustrates another example processing flow of an O-DU that can facilitate a wireless network device with multiple processing chains, in accordance with an embodiment of this disclosure;

FIG. 11 illustrates another example processing flow of an O-DU that can facilitate a wireless network device with multiple processing chains, in accordance with an embodiment of this disclosure;

FIG. 12 illustrates an example processing flow of an O-DU with two accelerator cards that can facilitate a wireless network device with multiple processing chains, in accordance with an embodiment of this disclosure;

FIG. 13 illustrates an example processing flow of an O-DU with two accelerator cards in one processing path that can facilitate a wireless network device with multiple processing chains, in accordance with an embodiment of this disclosure;

FIG. 14 illustrates another example processing flow of an O-DU with two accelerator cards in one processing path that can facilitate a wireless network device with multiple processing chains, in accordance with an embodiment of this disclosure;

FIG. 15 illustrates an example system architecture of an O-RAN centralized unit (DU; O-CU) that can facilitate a wireless network device with multiple processing chains, in accordance with an embodiment of this disclosure;

FIG. 16 illustrates an example system architecture of an O-DU with more than two processing paths that can facilitate a wireless network device with multiple processing chains, in accordance with an embodiment of this disclosure;

FIG. 17 illustrates an example system architecture of an O-CU with more than two processing paths that can facilitate a wireless network device with multiple processing chains, in accordance with an embodiment of this disclosure;

FIG. 18 illustrates another example system architecture that can facilitate a wireless network device with multiple processing chains, in accordance with an embodiment of this disclosure;

FIG. 19 illustrates an example process flow that can facilitate a wireless network device with multiple processing chains, in accordance with an embodiment of this disclosure;

FIG. 20 illustrates another example process flow that can facilitate a wireless network device with multiple processing chains, in accordance with an embodiment of this disclosure; and

FIG. 21 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies, and more generally to wireless communications.

It can be that an open radio access network (O-RAN) standard architecture (and hence products) does not consider ultra reliable and low latency communications (URLLC) service or low latency service. For example, it can be that most level 1 (L1; physical layer) and level 2 (L2; data link layer) tasks in a reference hardware/software (HW/SW) architecture of an O-RAN distributed unit (O-DU) are implemented in software in a server platform; and level 3 (L3; network layer) tasks in an O-RAN centralized unit (O-CU) are implemented by software in a server platform, too. The DU (except the scheduler) can take about 3 milliseconds (ms) in processing time, a scheduler in a DU can take at least 1.6 ms in processing time, and an O-CU can take about 100 microseconds (s). However, some URLLC use cases or low latency service use cases can have approximately a 1 ms-5 ms end-to-end (E2E) latency requirement. It can be that, according to URLLC simulation evaluation and observations, at least two hybrid automatic repeat request (HARQ) transmissions are desired to balance between meeting URLLC requirement of a packet and the whole URLLC system performance. The E2E latency from two HARQ transmissions in an O-RAN side can be approximately 2*2*(0.1+3+1.6)=18.8 ms, and this considers only CU and DU processing time. Given that, it can be that prior HW/SW architectures of O-DU/O-CU cannot meet these latency requirements. The present techniques can facilitate new O-DU/O-CU SW/HW architecture that can meet the URLLC requirements or latency requirements from a low latency service.

The present techniques can facilitate a wireless network device with a software/hardware architecture that can meet a URLLC requirement or a low latency requirement. This wireless network device architecture can implement wireless RAN functions. This can not only include O-CU/O-DU/O-RU, but also include baseband processing or an equivalent device. As a simplified example, this wireless network device can comprise an O-DU/O-CU. In other words, there can be examples of the present techniques that can generally be applied to baseband unit (BBU) architectures, such as those in sixth generation (6G) broadband cellular networks.

According to the present techniques, there can be more than one parallel processing approach for L1/L2 tasks in a DU. Different packet with different latency requirement can go through different processing methods for L1/L2 tasks in the DU.

One processing technique can have a processing delay N1, can include all or most L1 and L2 tasks in O-DU, and can is implemented by hardware—for example field programmable gate arrays (FPGAs), a digital signal processor (DSP), a specific hardware accelerator card or chipset, or anther hardware device.

Another processing technique can have a processing delay N2, N2>=N1, can includes all or most L1 and L2 tasks in O-DU, and can be implemented in software—for example software in a service platform. In some examples, N1 and N2 can be either max processing delay or the average processing delay.

That is, there can be examples where processing chain blocks can be hardware only, software only, or a combination of hardware and software. In general, it can be that more blocks in a chain that are hardware (compared with software) leads to a shorter processing time, while more blocks in a chain that are software (compared with hardware) leads to more flexibility and speed in changing a block (at a cost of processing time).

A priority/service indication and/or latency budget along with the packet can be introduced. The priority/service indication and/or latency budget of this packet can be used to choose different processing techniques, and can also be used to jump in line or preempt the ongoing processing resource/packets that are in the same processing flow/path.

The priority and packet delay budget of a packet can be used to determine different processing paths. Depending on the packet delay budget thresholds (that is, a latency requirement threshold of the packet), different processing paths can be dynamically selected. Techniques to pre-empt an ongoing processing to process a higher priority (or lower packet delay budget packet) in the same path/flow can be implemented.

Hardening the L1/L2 tasks according to the present techniques can reduce the corresponding processing time from approximately 3 ms to approximately 200-300 s.

According to the present techniques, there can be more than one parallel processing technique for L3 tasks in a CU. Different packet with different latency requirement can go through different processing techniques for L3 tasks in the CU.

In an example, one processing path/technique has a processing delay N3, where L3 tasks in O-CU are implemented in hardware—for example in FPGAs, a DSP, a hardware accelerator card or chipset, or another hardware device. Another processing path/technique can have a processing delay N4, N4>=N3, where L3 tasks are implemented in software—for example software in a service platform. In some examples, both N3 and N4 can be either max processing delay or the average processing delay.

According to the present techniques, priority/service indication and/or latency budget along with the packet can be introduced. The priority/service indication and/or latency budget of this packet can be used to choose different processing technique/path, and can also be used to jump in line or preempt the ongoing processing resource/packets that are in the same processing flow/path.

The priority and packet delay budget of a packet can be used to determine different processing paths. Depending on the packet delay budget thresholds (that is, a latency requirement threshold of the packet) different processing paths can be dynamically selected. Techniques to pre-empt an ongoing processing to process a higher priority (or lower packet delay budget packet) in the same path/flow can be considered.

For example, assume the PDB (packet delay budget) in a RAN of packet A is 2 ms, the HARQ procedure by using the first processing chain takes 0.3 ms, the HARQ transmission by using second processing chain takes 1.5 ms, and thus there are two HARQ transmission opportunities within the PDB of 2 ms. According to the present techniques, the first HARQ transmission of the Packet A is not the last HARQ transmission opportunity, and the first HARQ transmission can travel through the second processing chain, which can take 1.5 ms. If the first HARQ transmission for the packet A fails, a scheduler in L2 can make a decision that the second HARQ transmission is the last HARQ transmission opportunity, which should go through the first processing chains that only need 0.3 ms.

Hardening these L3 tasks can reduce the corresponding processing time from around 100 μs to 10 μs.

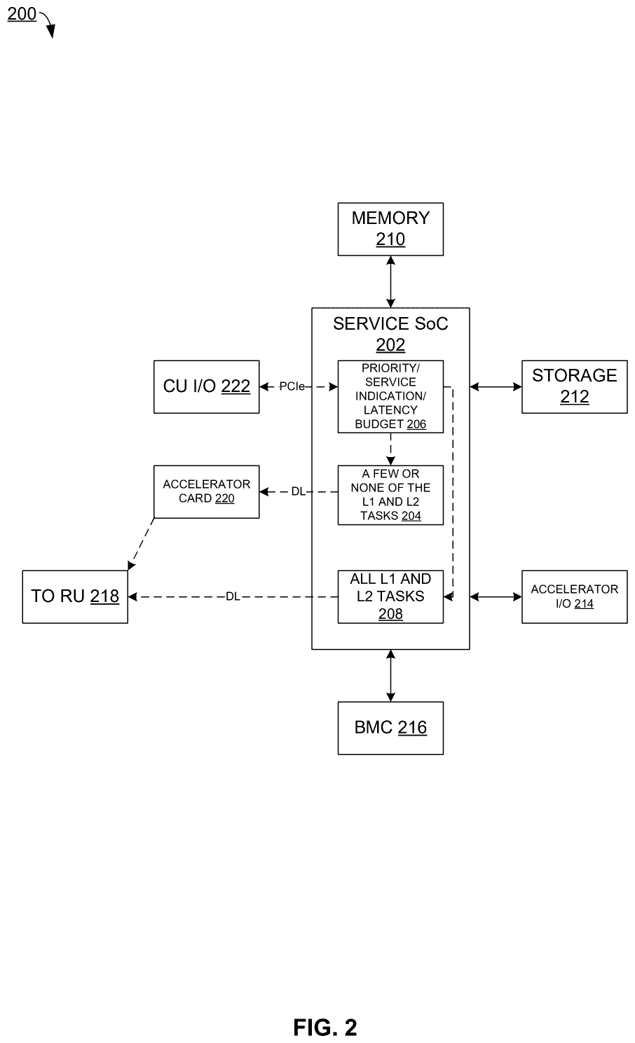

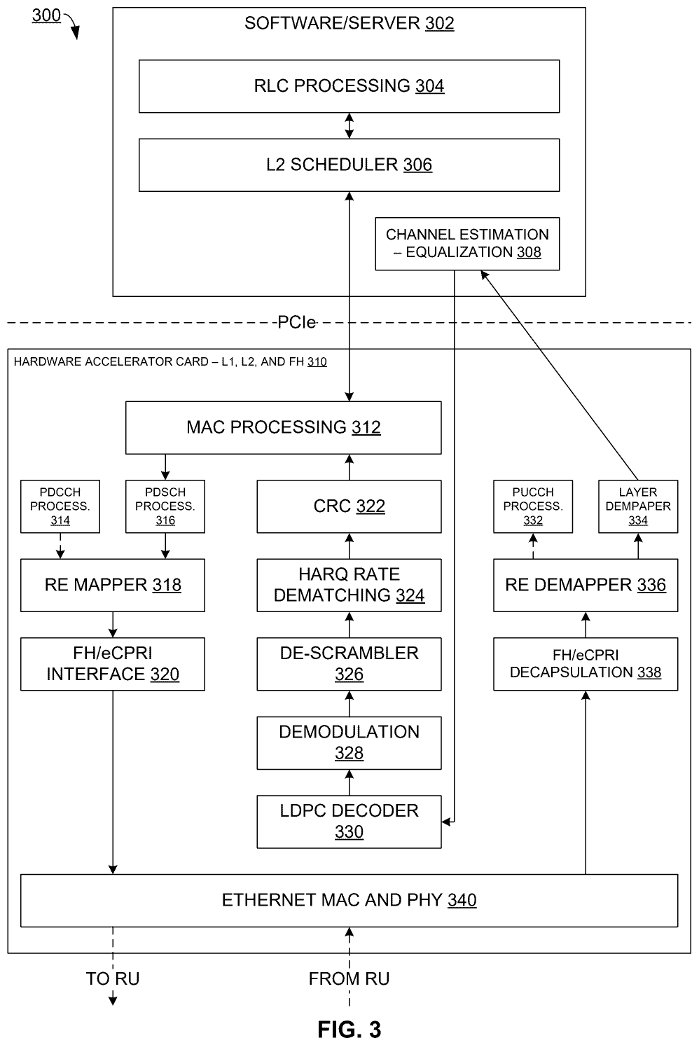

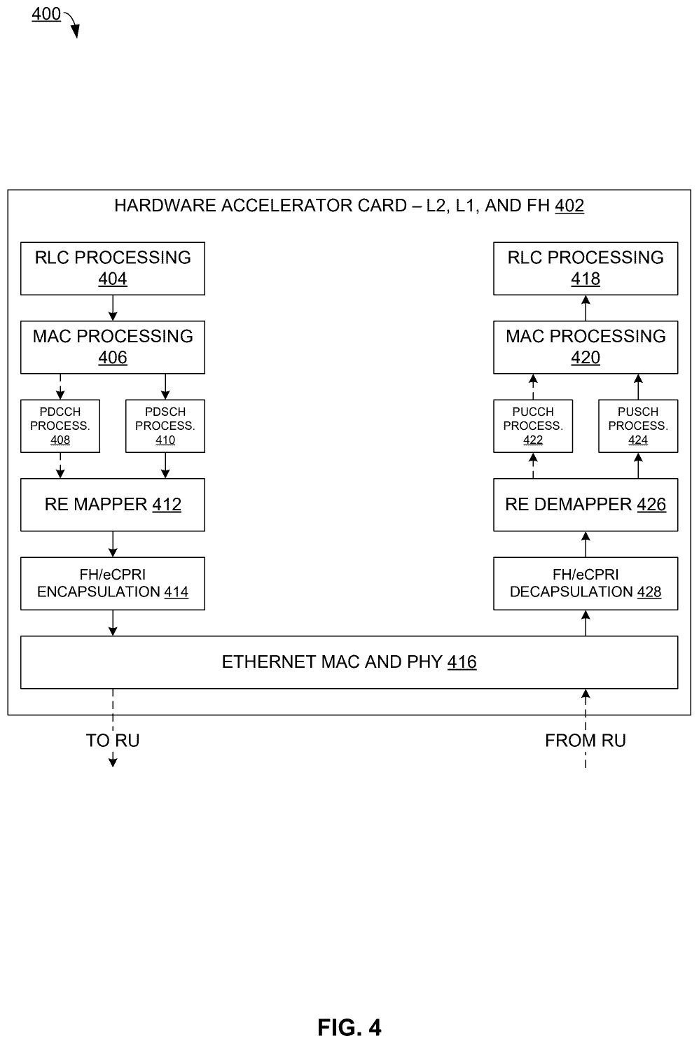

The following table illustrates a processing time reduction of different examples of the present techniques compared to a RAN implemented entirely in software.

| Processing time of | The first | The second |
|---|---|---|
| example implementations | processing chain | processing chain |
| FIG. 2 | 49.447% or 10% | 100% |
| FIG. 3 | 10% | 21.25% |
| FIG. 4 | 10% | 49.44% |

It can be that prior approaches to a O-DU/O-CU hardware/software architecture have only one processing path for all traffic regardless of different data traffics types and/or latency requirements. The present techniques can facilitate a path selector that can choose processing paths for different traffic or data based on a priority/service indication or PDB associated with the data packet. The processing paths considered can have different functions of the processing chain in software and/or hardware. Different example architectures are described below. Different architectures can be chosen considering the tradeoffs between processing delay (latency requirements) and cost of implementation.

According to the present techniques, an O-RAN device/base station can receive a packet, and the O-RAN device can have multiple processing paths for at least one L1 task, L2 task, or L3 task.

According to one or more than one of the priority indication, service indication, and latency budget for the packet, the O-RAN device/base station, CPU in the O-RAN device/base station, or host system in the O-RAN device can decide to have the packet go through one of the multiple processing paths/approaches.

It can be that one processing approach has a processing delay N1, includes all or most of L1 and L2 tasks, or L3 tasks, in an O-RAN device, and is implemented in hardware (for example FPGA, DSP, specific hardware accelerator card, chipset, or another hardware device). The other processing approach can have a processing delay N2, N2>=N1, includes all or most of L1 and L2 tasks, or L3 tasks, in the O-RAN device, and is implemented in software (for example software in a service platform). In some examples, both N1 and N2 can be either a maximum processing delay or an average processing delay.

It can be that one or more than one of the priority indication, service indication, and latency budget is conveyed along with the packet. Further, one or more than one of the priority indication, service indication, and latency budget can be carried in the header of the packet.

A second packet can be produced after the packet went through one of the multiple processing paths. The second packet can be delivered to another device (such as an O-RU, an O-CU, or a core network).

### Example Architectures and Processing Flows

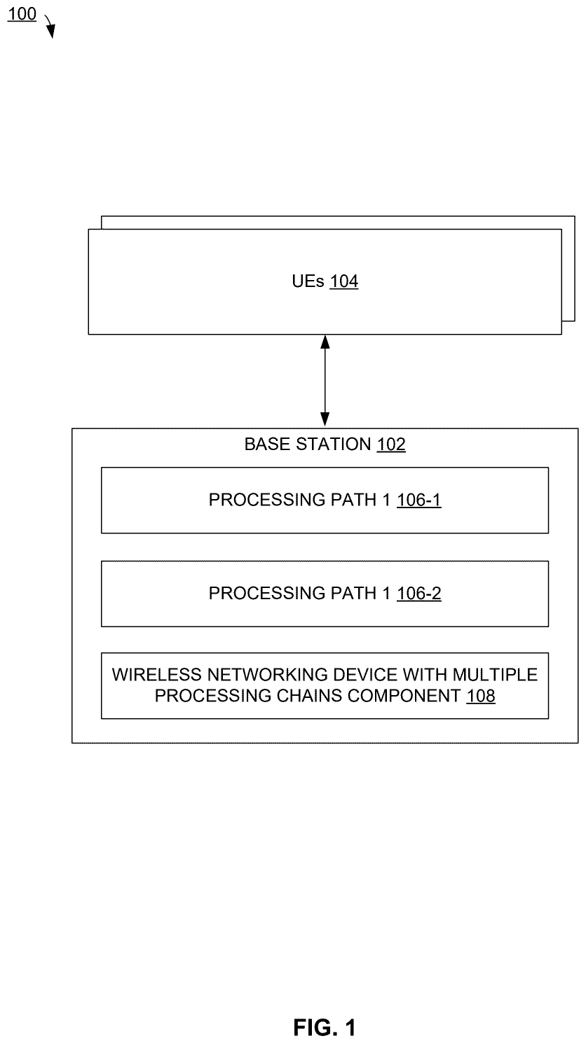

FIG. 1 illustrates an example system architecture 100 that can facilitate a wireless network device with multiple processing chains, in accordance with an embodiment of this disclosure.

System architecture 100 comprises base station 102 and UEs 104. In turn, base station 102 comprises processing path 1 106-1, processing path 2 106-2, and wireless network device with multiple processing chains component 108.

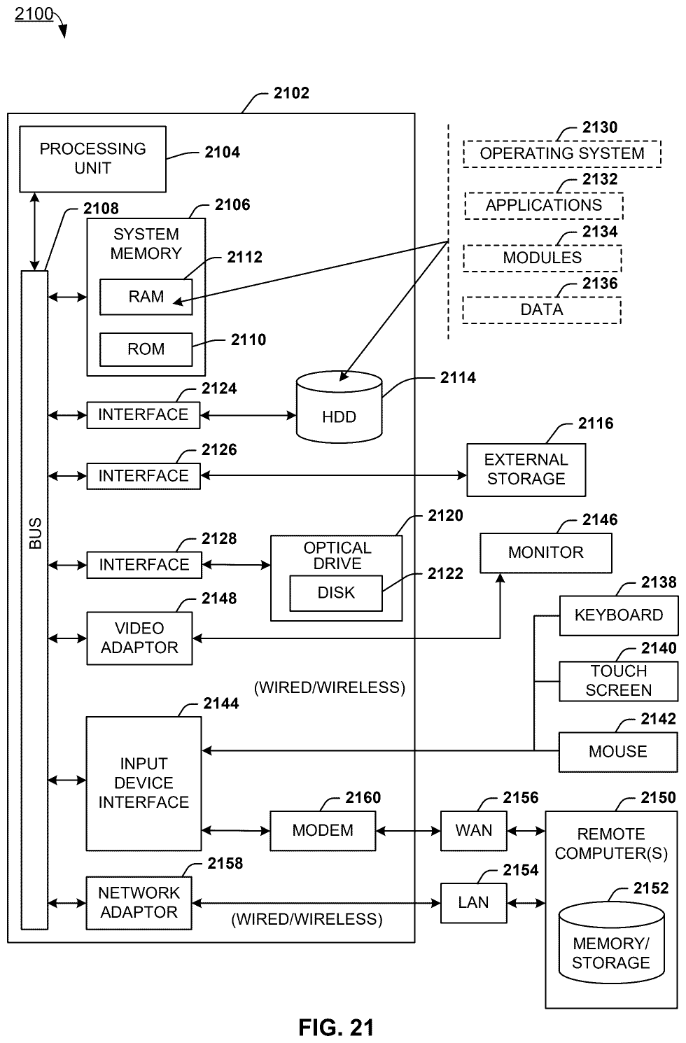

Each of base station 102 and/or UEs 104 can be implemented with part(s) of computing environment 2100 of FIG. 21.

Base station 102 can comprise two processing paths—processing path 1 106-1 and processing path 2 106-2—one of which can operate faster than the other (e.g., by implementing some features in hardware compared to in software). In selecting how to process data as part of communicating (e.g., transmitting) with a UE of UEs 104, wireless network device with multiple processing chains component 108 can select a processing path with which to process the data, and have the data processed via that selected processing path.

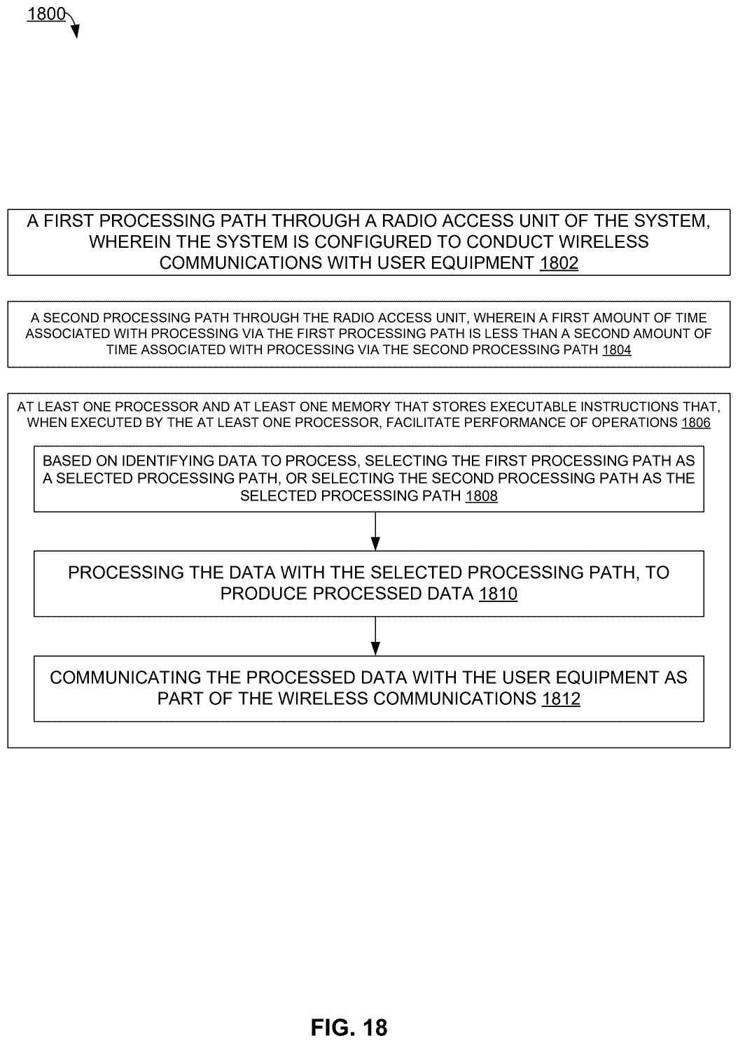

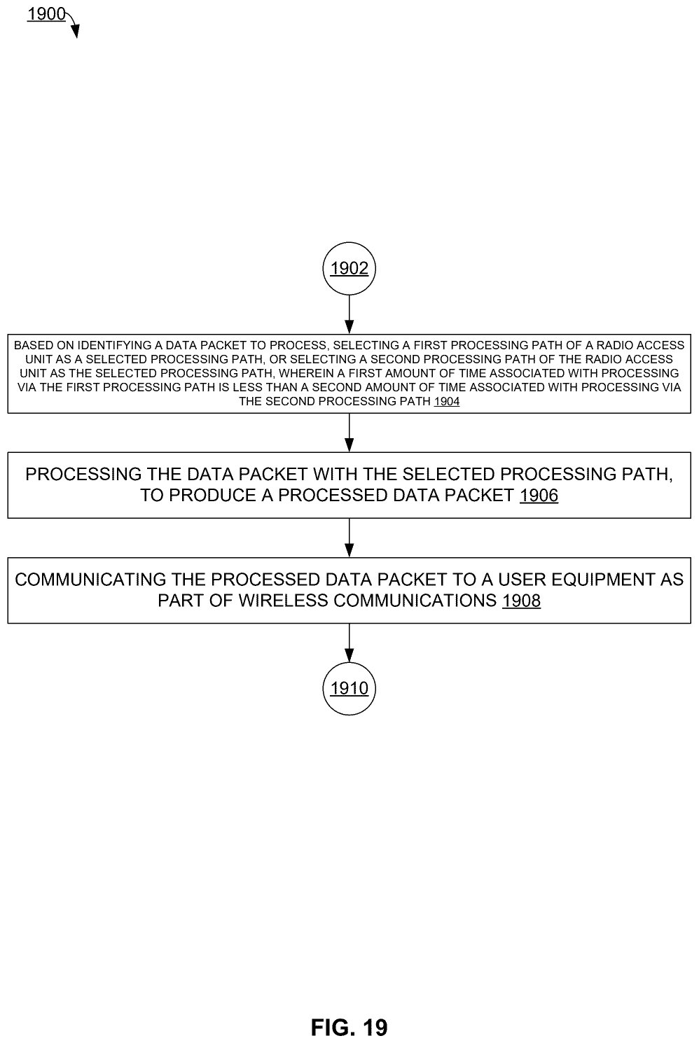

In some examples, wireless network device with multiple processing chains component 108 can implement part(s) of the process flows of FIGS. 18-19 to facilitate a wireless network device with multiple processing chains.

It can be appreciated that system architecture 100 is one example system architecture for a wireless network device with multiple processing chains, and that there can be other system architectures that facilitate a wireless network device with multiple processing chains.

FIG. 2 illustrates an example system architecture 200 of an O-DU that can facilitate a wireless network device with multiple processing chains, in accordance with an embodiment of this disclosure. In some examples, part(s) of system architecture 200 can be implemented by part(s) of system architecture 100 of FIG. 1 to facilitate a wireless network device with multiple processing chains.

System architecture 200 comprises service SoC 202, a few or none of the L1 and L2 tasks 204, priority/service indication/latency budget 206, all L1 and L2 tasks 208, memory 210, storage 212, accelerator input/output (I/O) 214, baseboard management controller (BMC) 216, to RU 218, accelerator card 220, and CU I/O 222.

An example of a hardware architecture according to the present techniques is shown in FIG. 2. A first processing path (in some examples, this can be taken by most L1 and L2 tasks) ca be implemented in hardware, such as a hardware accelerator card. Other L1 and/or L2 tasks can be implemented in a service system on a chip (SoC).

In an example with radio link control (RLC) processing, a L2 scheduler, channel quality indicator (CQI), channel estimation, timing estimation, and equalization can be implemented in software.

In an example, all L1 and L2 tasks can be implemented in hardware.

In another example, all L1 and L2 tasks are implemented in a service SoC.

A central processing unit (CPU) or host system in an O-DU can read/obtain or refer to a priority/service indication and/or latency budget of a packet from a CU. For example, a priority/service indication and/or latency budget can be added to a header of a packet from a CU or defined headers can be reused for this purpose. A CPU or host system in an O-DU can instruct the packet to use the first processing path where the priority indication is high, a service indication is latency-sensitive/URLLLC, a latency budget is less than a threshold, or there is only one transmission within a latency budget. Otherwise, the packet can travel through a second processing path. In some general examples, a packet can be processed through a path that has a lowest latency flow (e.g., more functions in hardware) for URLLC or latency-sensitive 5g quality-of-service indicator (5QI) related packets, and through alternate paths for lesser latency sensitive packets. The paths can be chosen based on a degree of latency requirements (e.g. a packet delay budget (PDB)). latency or PDB thresholds can be defined and used to select such processing flow choices.

Where a non-URLLC service does not have such strict processing time requirements, the non-URLLC service can go through the second processing path, which can be software-based, and used for L1 and L2 tasks are desired for latency-tolerance service.

In an example, as long as there is enough delay budget for more than one transmission for a URLLC service packet at the moment, the URLLC service packet can go through the second processing path because there is enough time for second transmission even though the first transmission fails. In some examples, through the second processing path can be helpful to improve system performance, spectrum efficiency, or support more users by choosing an aggregative modulation and coding scheme (MCS) for the first transmission.

In another example, all URLLC service packets with a priority/service indication or latency budget go through the first processing path.

FIG. 3 illustrates an example system architecture 300 of an O-DU processing path that can facilitate a wireless network device with multiple processing chains, in accordance with an embodiment of this disclosure. In some examples, part(s) of system architecture 300 can be implemented by part(s) of system architecture 100 of FIG. 1 to facilitate a wireless network device with multiple processing chains.

System architecture 300 comprises software/server 302, radio link control (RLC) processing 304, L2 scheduler 306, channel estimation—equalization 308, hardware accelerator card—L1, L2, and FH 310, MAC processing 312, physical downlink control channel (PDCCH) processing 314, physical downlink shared channel (PDSCH) processing 316, resource element (RE) mapper 318, FH/enhanced common public radio (eCPRI) interface 320, cyclic redundancy check (CRC) 322, HARQ rate dematching 324, de-scrambler 326, demodulation 328, low density parity check (LDPC) decoder 330, physical uplink control channel (PUCCH) processing 332, layer demapper 334, RE demapper 336, FH/eCPRI decapsulation 338, and ethernet MAC and PHY 340.

FIG. 3 can generally illustrate an example of a first processing path from FIG. 2.

In an example, RLC processing, a L2 scheduler, CQI, channel estimation, timing estimation, and equalization can be software implemented in a service SoC.

Normal media access control (MAC) processing except for a MAC scheduler (where normal processing can include adding sub headers, and hybrid automatic repeat request (HARQ) feedback) can be implemented in a hardware accelerator card.

A MAC scheduler (which can be referred to as an L2 scheduler) can be software implemented in a server SoC.

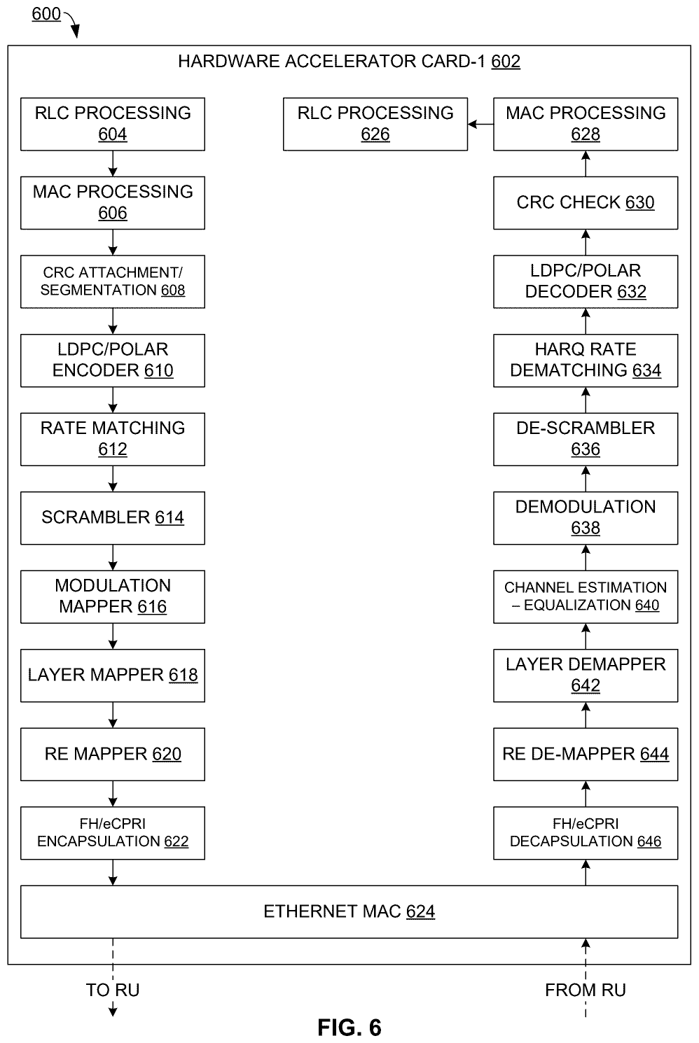

Other examples of the first processing path in FIG. 2 are shown in FIGS. 4 and 6, where all L1 and L2 tasks are implemented in a hardware accelerator card.

FIG. 4 illustrates another example system architecture 400 of an O-DU processing path that can facilitate a wireless network device with multiple processing chains, in accordance with an embodiment of this disclosure. In some examples, part(s) of system architecture 400 can be implemented by part(s) of system architecture 100 of FIG. 1 to facilitate a wireless network device with multiple processing chains.

System architecture 400 comprises hardware accelerator card—L2, L1, and FH 402, RLC processing 404, MAC processing 406, PDCCH processing 408, PDSCH processing 410, RE mapper 412, FH/eCPRI encapsulation 414, ethernet MAC and PHY 416, RLC processing 418, MAC processing 420, PUCCH processing 422, PUSCH processing 424, RE demapper 426, and FH/eCPRI decapsulation 428.

In example simulations, it can be that CQI, channel estimation, and timing estimation take 87.1%*45.1%*88.6%*(48.2%+40.4%)=31% of the gNB/O-RAN processing time.

It can be that a scheduler in the MAC layer takes 49%*12.5%=6.13% of the gNB/O-RAN processing time.

Comparing these simulated results of the present techniques with processing time with a RAN implemented all in software, the processing time of the second processing chain is 10%, the processing time of the first processing chain is (100%−(31%+12.5%+0.33%))*10%+(31%+12.5%+0.33%)=49.447%, under an assumption that the processing time in a chipset is about 1/10 of that in software.

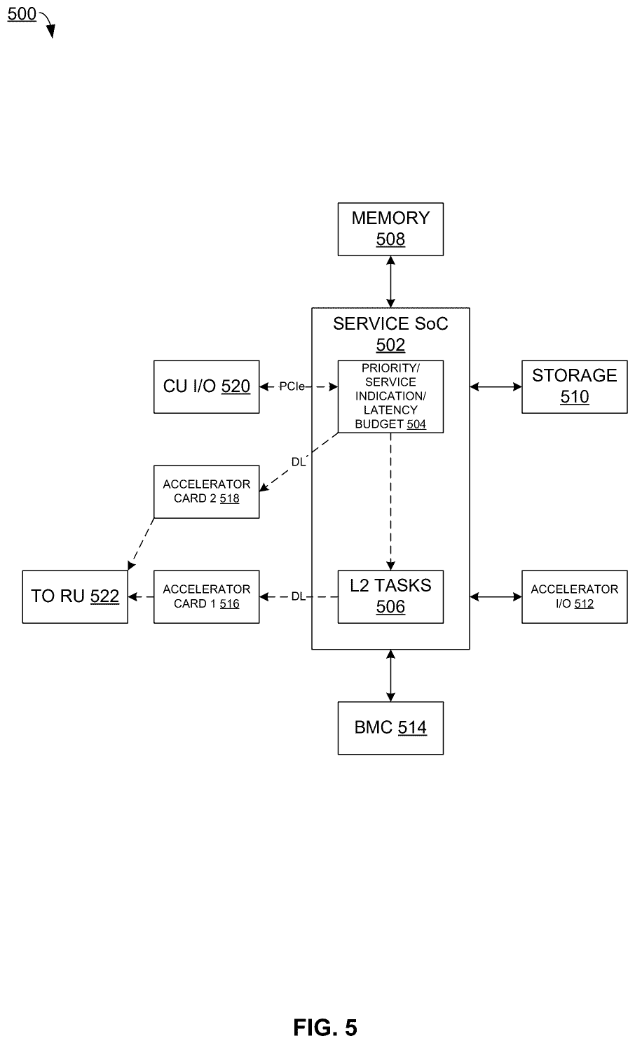

FIG. 5 illustrates another example system architecture 500 of an O-DU that can facilitate a wireless network device with multiple processing chains, in accordance with an embodiment of this disclosure. In some examples, part(s) of system architecture 500 can be implemented by part(s) of system architecture 100 of FIG. 1 to facilitate a wireless network device with multiple processing chains.

System architecture 500 comprises service SoC 502, priority/service indication/latency budget 504, L2 tasks 506, memory 508, storage 510, accelerator I/O 512, BMC 514, accelerator card 1 516, accelerator card 2 518, CU I/O 520, and to RU 522.

FIG. 5 illustrates an example where, in the first processing path, all L1 and L2 tasks are implemented in a hardware accelerator card 1. In the second processing path, L2 tasks are implemented in a software service SoC. L1 tasks can be implemented in an accelerator card 2.

A CPU or host system in a O-DU can read/obtain or refer to a priority/service indication and/or latency budget of the packet from the CU. For example, the priority/service indication and/or latency budget can be added in a header of the packet from a CU or defined headers can be reused for such purposes. The CPU or host system in O-DU can instruct the packet to go through the first processing path if the priority indication is high, service indication is latency-sensitive/URLLC, latency budget is less than one threshold or only one transmission within the latency budget. Otherwise, the packet can go through the second processing path. In general, the packet can be processed through the path that has the lowest latency flow (for example, more functions in hardware) for URLLC or latency sensitive 5QI related packets, and through alternate paths for lesser latency sensitive packets. The paths can be chosen based on the degree of latency requirements (e.g., a PDB). Latency or PDB thresholds can be defined and used to select such processing flow choices.

Where non-URLLC service does not have such strict processing time requirements, a non-URLLC service can go through the second processing path. That is, software based L2 tasks can be desired for latency-tolerance service.

In an example, as long as there is enough delay budget for more than one transmission even for the URLLC service packet at the moment, the URLLC service packet can go through the second processing path because there is enough time for second transmission even though the first transmission is failed. Going through the second processing path can be helpful to improve system performance, spectrum efficiency or support more users by choosing aggregative MCS for the first transmission.

In another example, all URLLC service packets with priority/service indication or latency budget can go through the first processing path.

FIG. 6 illustrates an example system architecture 600 of an accelerator card that can facilitate a wireless network device with multiple processing chains, in accordance with an embodiment of this disclosure. In some examples, part(s) of system architecture 600 can be implemented by part(s) of system architecture 100 of FIG. 1 to facilitate a wireless network device with multiple processing chains.

System architecture 600 comprises hardware accelerator card-1 602, RLC processing 604, MAC processing 606, CRC attachment/segmentation 608, LDPC/polar encoder 610, rate matching 612, scrambler 614, modulation mapper 616, layer mapper 618, RE mapper 620, FH/eCPRI encapsulation 622, ethernet MAC 624, RLC processing 626, MAC processing 628, CRC check 630, LDPC/polar decoder 632, HARQ rate dematching 634, de-scrambler 636, demodulation 638, channel estimation—equalization 640, layer demapper 642, RE de-mapper 644, and FH/eCPRI decapsulation 646.

FIG. 6 can illustrate the accelerator card 1 in the first processing path of FIG. 5. In FIG. 6, the task blocks in L1 and L2 are hardened, which can be implemented by a chipset, a field programmable gate array (FPGA), a digital signal processor (DSP), a hardware accelerator card, or other hardware.

With this example approach, the processing time for L1 and L2 tasks can be reduced from about 3 milliseconds (ms) to about 300 microseconds (s) compared with an example where all L1 and L2 tasks are software implemented.

This processing path with accelerator card-1 can be suitable to a packet that has a strict latency budget. It can involve sacrificing system spectrum efficiency to support URLLC key performance indicators (KPIs).

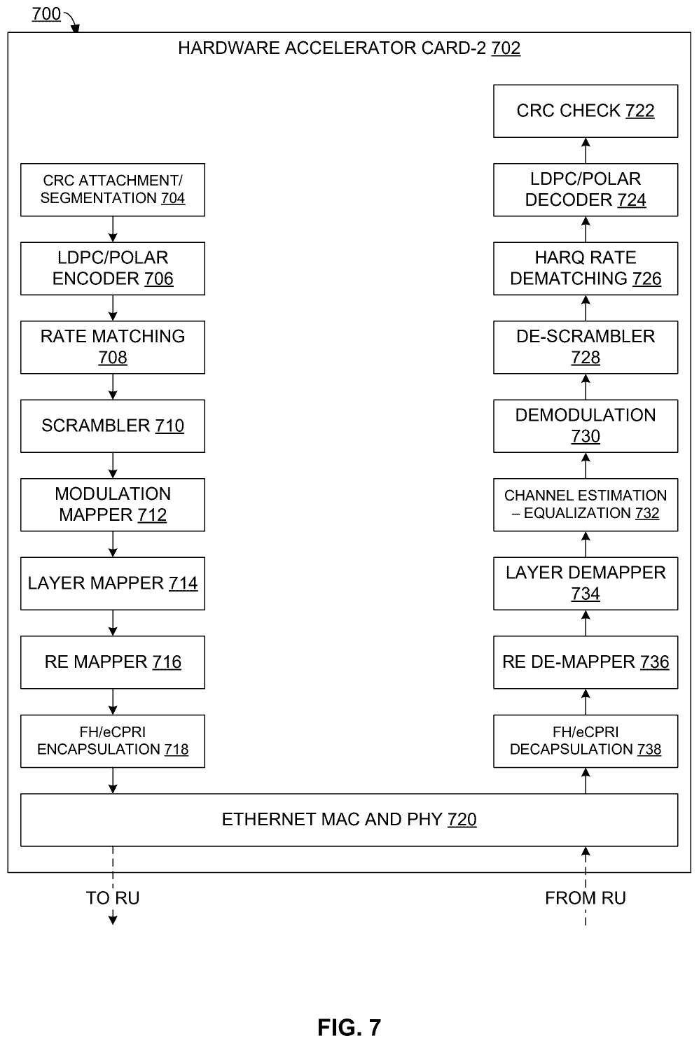

FIG. 7 illustrates another example system architecture 700 of an accelerator card that can facilitate a wireless network device with multiple processing chains, in accordance with an embodiment of this disclosure. In some examples, part(s) of system architecture 700 can be implemented by part(s) of system architecture 100 of FIG. 1 to facilitate a wireless network device with multiple processing chains.

System architecture 700 comprises hardware accelerator card-2 702, CRC attachment/segmentation 704, LDPC/polar encoder 706, rate matching 708, scrambler 710, modulation mapper 712, layer mapper 714, RE mapper 716, FH/eCPRI encapsulation 718, ethernet MAC and PHY 720, CRC check 722, LDPC/polar decoder 724, HARQ rate dematching 726, de-scrambler 728, demodulation 730, channel estimation—equalization 732, layer demapper 734, RE de-mapper 736, and FH/eCPRI decapsulation 738.

FIG. 7 illustrates detailed task blocks within accelerator card-2 in second processing path.

In this example, the task blocks in L1 are hardened, and can be implemented by a chipset, FPGA, DSP, hardware accelerator card, or another hardware device. An advantage of this approach is that the processing time for L1 can be reduced compared with an example where L1 tasks are software implemented.

This processing path can have a feasibility to change/update design for these L2 tasks and a MAC scheduler, which can be different for different KPI targets—for example, maximizing the system spectrum efficiency (that is, system throughput) or user perceived throughput (UPT) coverage.

This processing path can be used for non-URLLC service, for example mobile broadband (MBB) service. This processing path can be used for a URLLC service packet, too, as long as there is enough delay budget for more than one transmission.

Another example is that a URLLC service packet with priority indicator, service ID, or latency budget can go to the first processing path.

Comparing the present time of the present example with processing time with RAN implemented all in software, the processing time of the second processing chain is 10%, and the processing time of the first processing chain is (100%−12.5%)*10%+12.5%=21.25%.

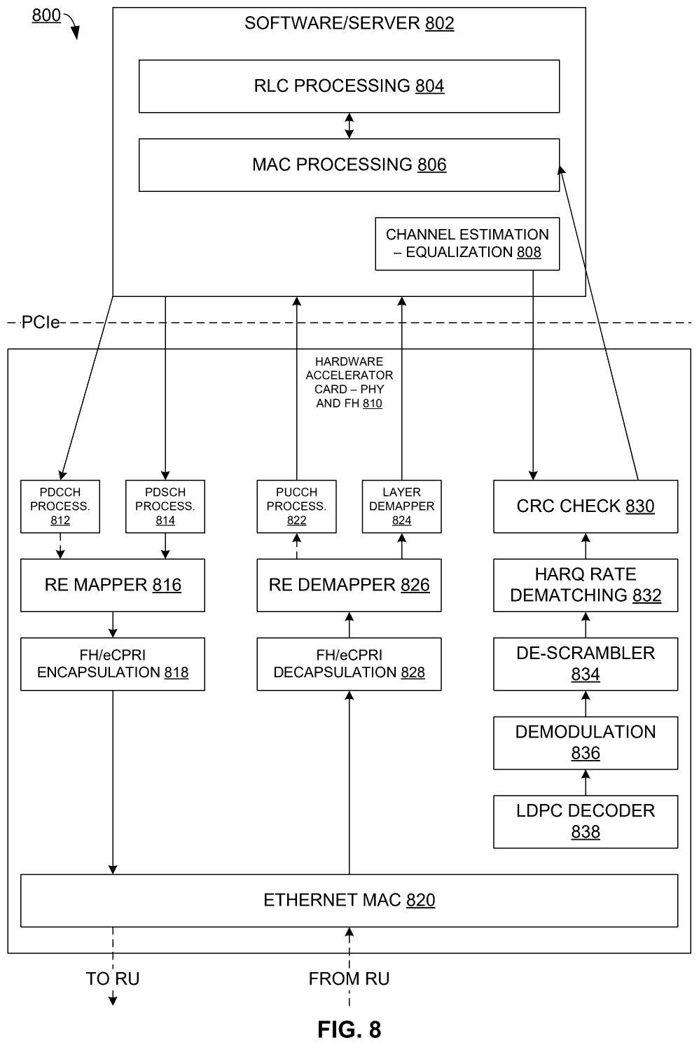

FIG. 8 illustrates an example processing flow 800 of an O-DU that can facilitate a wireless network device with multiple processing chains, in accordance with an embodiment of this disclosure. In some examples, part(s) of processing flow 800 can be implemented by part(s) of system architecture 100 of FIG. 1 to facilitate a wireless network device with multiple processing chains.

Processing flow 800 comprises software/server 802, RLC processing 804, MAC processing 806, channel estimation—equalization 808, hardware accelerator card—PHY and FH 810, PDCCH processing 812, PDSCH processing 814, RE mapper 816, FH/eCPRI encapsulation 818, ethernet MAC 820, PUCCH processing 822, layer demapper 824, RE demapper 826, FH/eCPRI decapsulation 828, CRC check 830, HARQ rate dematching 832, de-scrambler 834, demodulation 836, and LDPC decoder 838.

The first processing path implements L1 and L2 tasks in hardware, for example the accelerator card 1

The second processing path implements L2 tasks, CQI, channel estimation, timing estimation, and equalization in a service SoC software implementation. Other L1 tasks are implemented in an accelerator card, as shown in FIG. 8.

The CPU or host system in O-DU can read/obtain or refer to the priority/service indication and/or latency budget of the packet from CU, for example the priority/service indication and/or latency budget can be added in a header of the packet from a CU, or defined headers can be reused for such purposes. The CPU or host system in O-DU can instruct the packet to go through the first processing path if the priority indication is high, service indication is latency-sensitive/URLLC, latency budget is less than a threshold, or there is only one transmission within the latency budget. Otherwise, the packet can go through the second processing path. In general, the packet can be processed through the path which has the lowest latency flow (for example more functions in hardware) for URLLC or latency sensitive 5QI related packets and through alternate paths for lesser latency sensitive packets. The paths can be chosen based on the degree of latency requirements (PDB). latency or PDB thresholds can be defined and used to select such processing flow choices.

In examples where non-URLLC service does not have such strict processing time requirements, non-URLLC service can go through the second processing path: software based L2 tasks, and CQI, channel estimation, timing estimation can be used for latency-tolerance service and can improve system throughput.

This second processing path can be used for URLLC service packet where there is enough delay budget for more than one transmission for this URLLC service packet.

In some examples, a URLLC service packet with a priority indicator, service ID, or latency budget can go to the first processing path.

Compared with processing time with RAN implemented all in software, the processing time of the second processing chain can be 10%, and the processing time of the first processing chain is (100%−(31%+12.5%+0.33%))*10%+(31%+12.5%+0.33%)=49.447%.

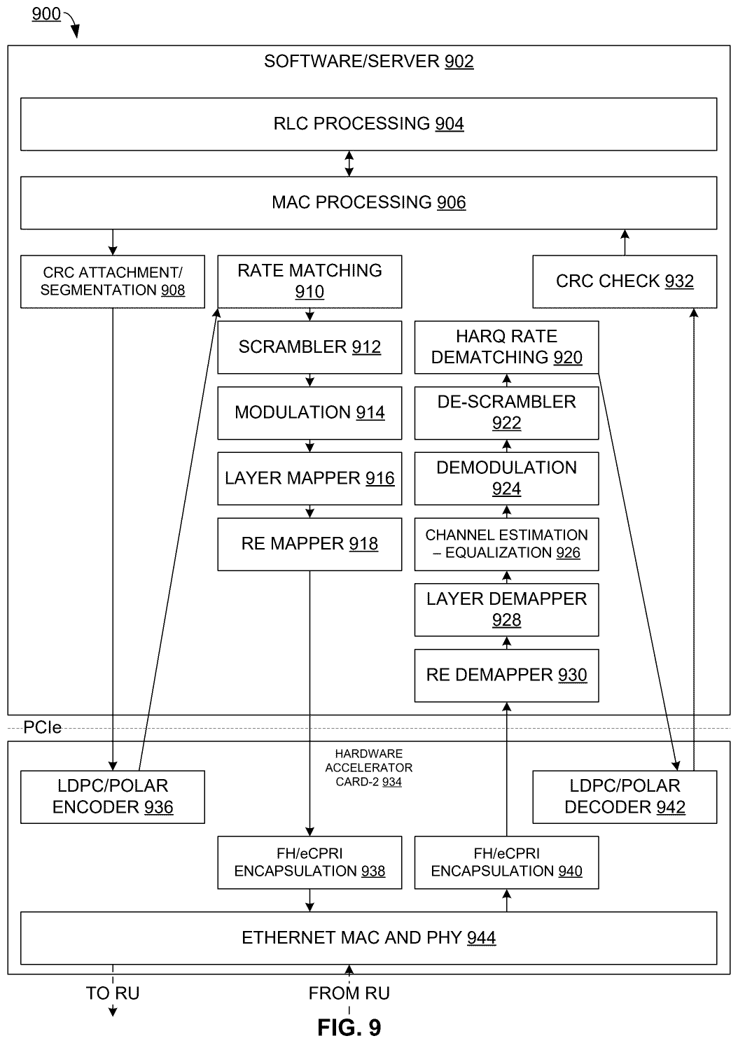

FIG. 9 illustrates another example processing flow 900 of an O-DU that can facilitate a wireless network device with multiple processing chains, in accordance with an embodiment of this disclosure. In some examples, part(s) of processing flow 900 can be implemented by part(s) of system architecture 100 of FIG. 1 to facilitate a wireless network device with multiple processing chains.

Processing flow 900 comprises software/server 902, RLC processing 904, MAC processing 906, CRC attachment/segmentation 908, rate matching 910, scrambler 912, modulation 914, layer mapper 916, RE mapper 918, HARQ rate dematching 920, de-scrambler 922, demodulation 924, channel estimation—equalization 926, layer demapper 928, RE demapper 930, CRC check 932, hardware accelerator card-2 934, LDPC/polar encoder 936, FH/eCPRI encapsulation 938, FH/eCPRI encapsulation 940, LDPC/polar decoder 942, and ethernet MAC and PHY 944.

The second processing path is shown in FIG. 9.

The first processing path is that all L1 and L2 tasks are implemented in accelerator card 1

The second processing path can be an encoder, decoder, fronthaul (FH) encapsulation/decapsulation in a hardware accelerator card, and other L1 and L2 tasks are in a service SoC software implementation, as shown in FIG. 9.

The CPU or host system in a O-DU can read/obtain, or refer to the priority/service indication, and/or latency budget of the packet from CU—for example, the priority/service indication and/or latency budget can be added in a header of the packet from the CU, or defined headers can be reused for such purposes. The CPU or host system in a O-DU can instruct the packet to go through the first processing path if the priority indication is high, service indication is latency-sensitive/URLLC, latency budget is less than one threshold, or there is only one transmission within the latency budget. Otherwise, the packet can go through the second processing path. In general, the packet can be processed through the path that has the lowest latency flow (for example more functions in hardware) for URLLC or latency-sensitive 5QI related packets, and through alternate paths for lesser latency sensitive packets. The paths can be chosen based on the degree of latency requirements (PDB). Latency or PDB thresholds can be defined and used to select such processing flow choices.

Where non-URLLC service does not have such strict processing time requirements, non-URLLC service can go through the second processing path: software-based L1 and L2 tasks in the second processing path can be software implemented in a server.

This second processing path can be used for URLLC service packets, if there is enough delay budget for more than one transmission for this URLLC service packet.

In another example, a URLLC service packet with priority indicator or service ID or latency budget can go to the first processing path.

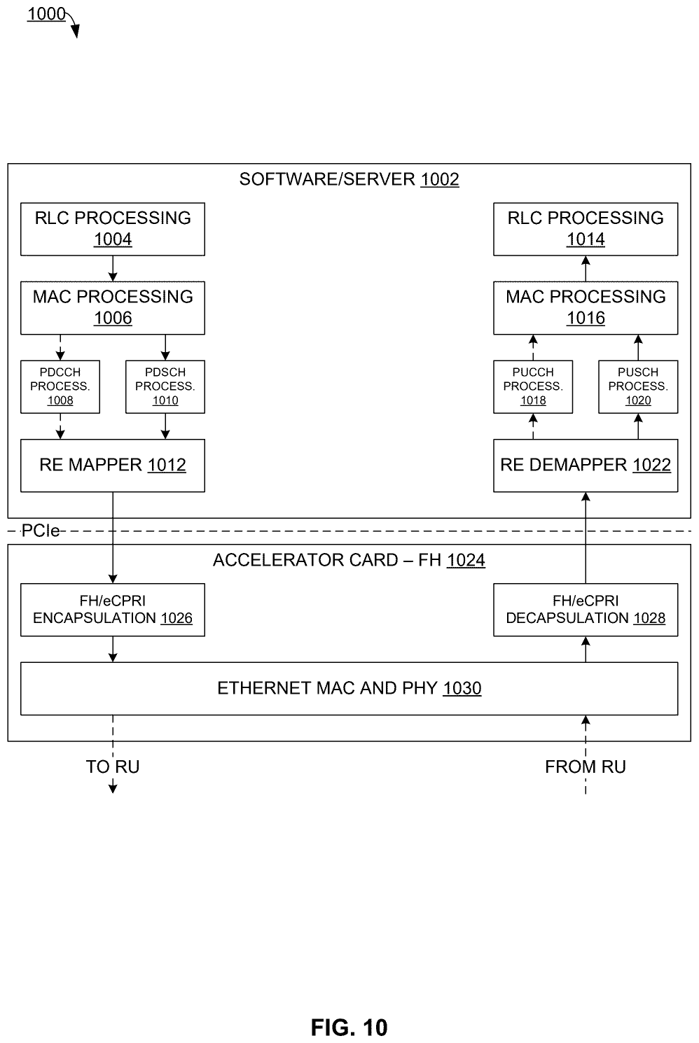

FIG. 10 illustrates another example processing flow 1000 of an O-DU that can facilitate a wireless network device with multiple processing chains, in accordance with an embodiment of this disclosure. In some examples, part(s) of processing flow 1000 can be implemented by part(s) of system architecture 100 of FIG. 1 to facilitate a wireless network device with multiple processing chains.

Processing flow 1000 comprises software/server 1002, RLC processing 1004, MAC processing 1006, PDCCH processing 1008, PDSCH processing 1010, RE mapper 1012, RLC processing 1014, MAC processing 1016, PUCCH processing 1018, PUSCH processing 1020, RE demapper 1022, accelerator card—FH 1024, FH/eCPRI encapsulation 1026, FH/eCPRI decapsulation 1028, and ethernet MAC and PHY 1030.

In FIG. 10, in the first processing path, L1 and L2 tasks are implemented in the accelerator card 1. The second processing path can handle fronthaul (FH) encapsulation/decapsulation, ethernet MAC and physical layer (PHY), and can be implemented in hardware, for example in a hardware accelerator card. Other L1 and L2 tasks can be software implemented, for example software in a service SoC, as shown in FIG. 10.

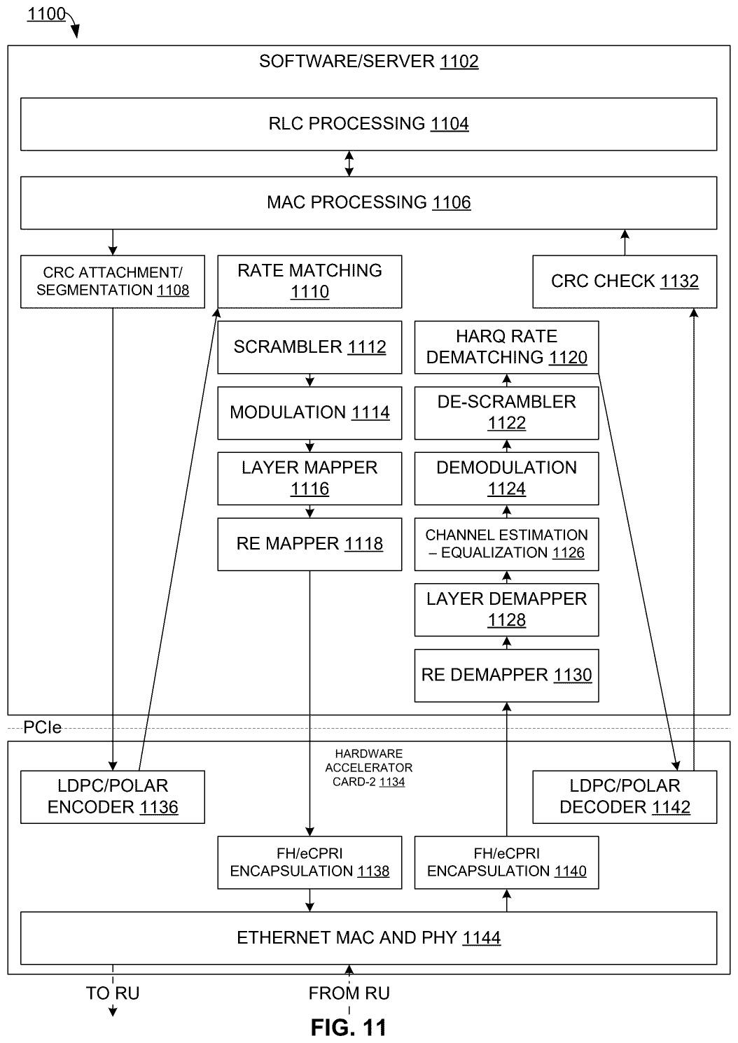

The second processing path can handle encoder, decoder, fronthaul (FH) encapsulation/decapsulation, ethernet MAC and PHY, and be implemented in hardware, for example in a hardware accelerator card. Other L1 and L2 tasks can be software implemented, for example in a service SoC, as shown in FIG. 11.

The CPU or host system in an O-DU can read/obtain or refer to the priority/service indication, and/or latency budget of the packet from CU—for example the priority/service indication and/or latency budget can added in a header of the packet from CU, or defined headers can be reused for such purposes. The CPU or host system in a O-DU can instruct the packet to go through the first processing path if the priority indication is high, service indication is latency-sensitive/URLLC, latency budget is less than one threshold, or there is only one transmission within the latency budget. Otherwise, the packet can go through the second processing path. In general, the packet can be processed through the path that has the lowest latency flow (for example more functions in hardware) for URLLC, or latency sensitive 5QI related packets, and through alternate paths for lesser latency sensitive packets. The paths can be chosen based on the degree of latency requirements (PDB). Latency or PDB thresholds can be defined and used to select such processing flow choices.

In examples where a non-URLLC service does not have such strict processing time requirements, non-URLLC service can go through the second processing path: software based most of L1 and L2 tasks in the second processing path can be software implemented in a server.

This second processing path can be used for URLLC service packets, too, as long as there is enough delay budget for more than one transmission for this URLLC service packet.

In another example, a URLLC service packet with priority indicator or service ID or latency budget can go to the first processing path.

The first processing path in FIG. 2 is shown in FIG. 10, where FH encapsulation/decapsulation, and ethernet MAC and PHY are implemented in a hardware accelerator. Other L1 and L2 tasks can be software implemented in a server SoC.

The first processing path in FIG. 5 is shown in FIG. 10, where FH encapsulation/decapsulation, and ethernet MAC and PHY are implemented in a hardware accelerator. Other L1 and L2 tasks are software implemented in a server SoC.

FIG. 11 illustrates another example processing flow 1100 of an O-DU that can facilitate a wireless network device with multiple processing chains, in accordance with an embodiment of this disclosure. In some examples, part(s) of processing flow 1100 can be implemented by part(s) of system architecture 100 of FIG. 1 to facilitate a wireless network device with multiple processing chains.

Processing flow 1100 comprises software/server 1102, RLC processing 1104, MAC processing 1106, CRC attachment/segmentation 1108, rate matching 1110, scrambler 1112, modulation 1114, layer mapper 1116, RE mapper 1118, HARQ rate dematching 1120, de-scrambler 1122, demodulation 1124, channel estimation—equalization 1126, layer demapper 1128, RE demapper 1130, CRC check 1132, hardware accelerator card-2 1134, LDPC/polar encoder 1136, FH/eCRPI encapsulation 1138, FH/eCRPI decapsulation 1140, LDPC/polar decoder 1142, and ethernet MAC and PHY 1144.

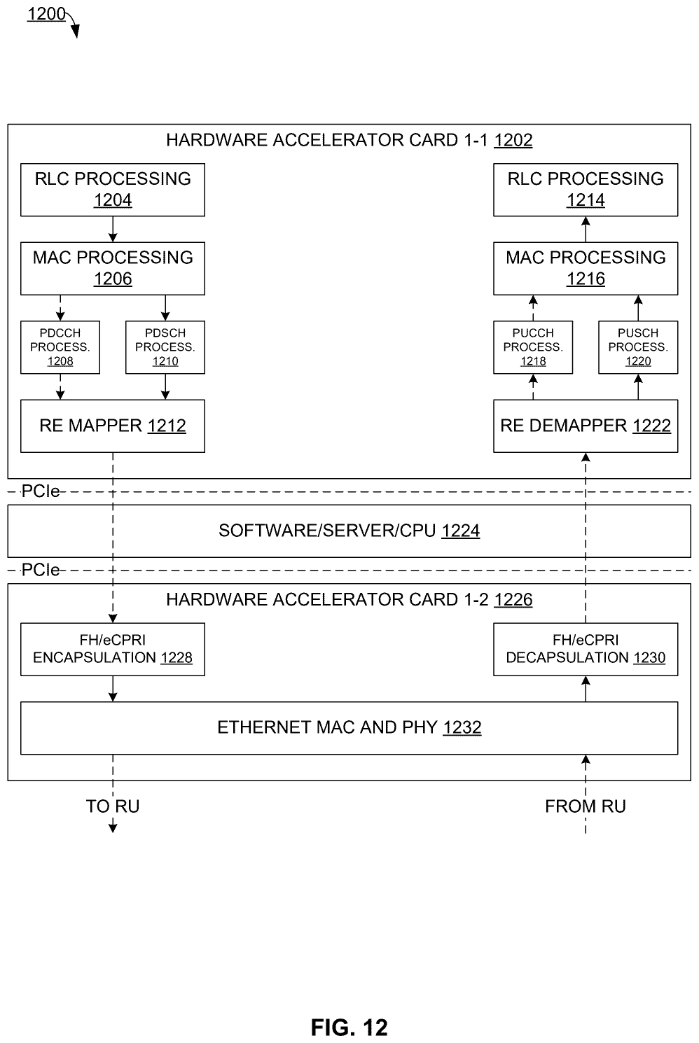

FIG. 12 illustrates an example processing flow 1200 of an O-DU with two accelerator cards that can facilitate a wireless network device with multiple processing chains, in accordance with an embodiment of this disclosure. In some examples, part(s) of processing flow 1200 can be implemented by part(s) of system architecture 100 of FIG. 1 to facilitate a wireless network device with multiple processing chains.

Processing flow 1200 comprises hardware accelerator card 1-1 1202, RLC processing 1204, MAC processing 1206, PDCCH processing 1208, PDSCH processing 1210, RE mapper 1212, RLC processing 1214, MAC processing 1216, PUCCH processing 1218, PUSCH processing 1220, RE demapper 1222, software/server/CPU 1224, hardware accelerator card1-2 1226, FH/eCPRI encapsulation 1228, FH/eCPRI decapsulation 1230, and ethernet MAC and PHY 1232.

The first processing path in FIGS. 2 and 5 has two accelerator cards, shown in FIG. 12. FH encapsulation/decapsulation, and ethernet MAC and PHY can be implemented in one hardware accelerator card. Other L1 and L2 tasks can be implemented in the other hardware accelerator card.

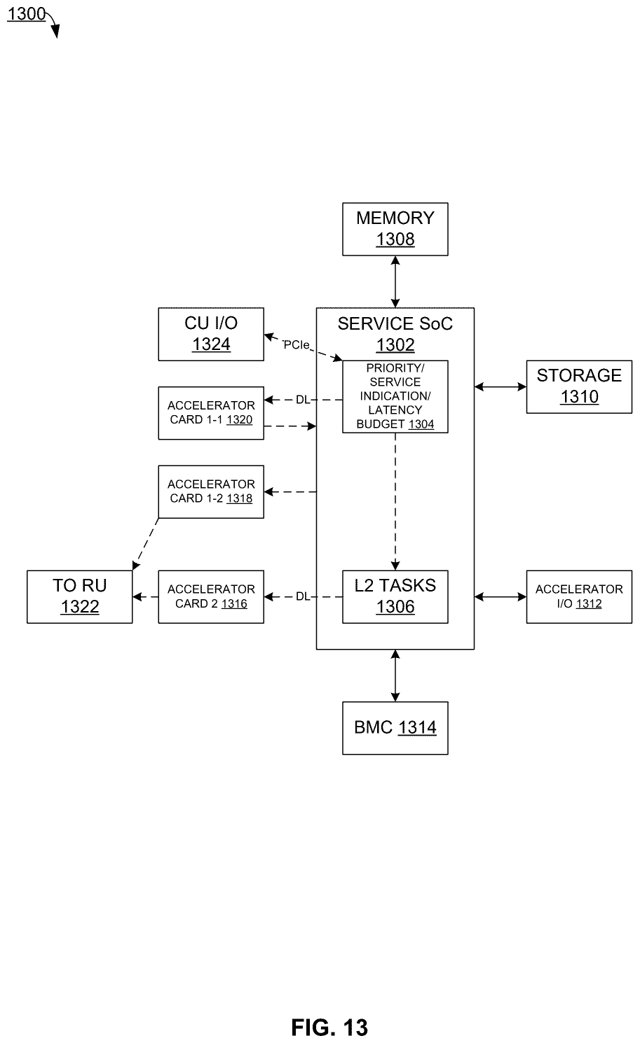

FIG. 13 illustrates an example processing flow 1300 of an O-DU with two accelerator cards in one processing path that can facilitate a wireless network device with multiple processing chains, in accordance with an embodiment of this disclosure. In some examples, part(s) of processing flow 1300 can be implemented by part(s) of system architecture 100 of FIG. 1 to facilitate a wireless network device with multiple processing chains.

Processing flow 1300 comprises service SoC 1302, priority/service indication/latency budget 1304, L2 tasks 1306, memory 1308, storage 1310, accelerator I/O 1312, BMC 1314, accelerator card 2 1316, accelerator card 1-2 1318, accelerator card 1-1 1320, to RU 1322, and CU I/O 1324.

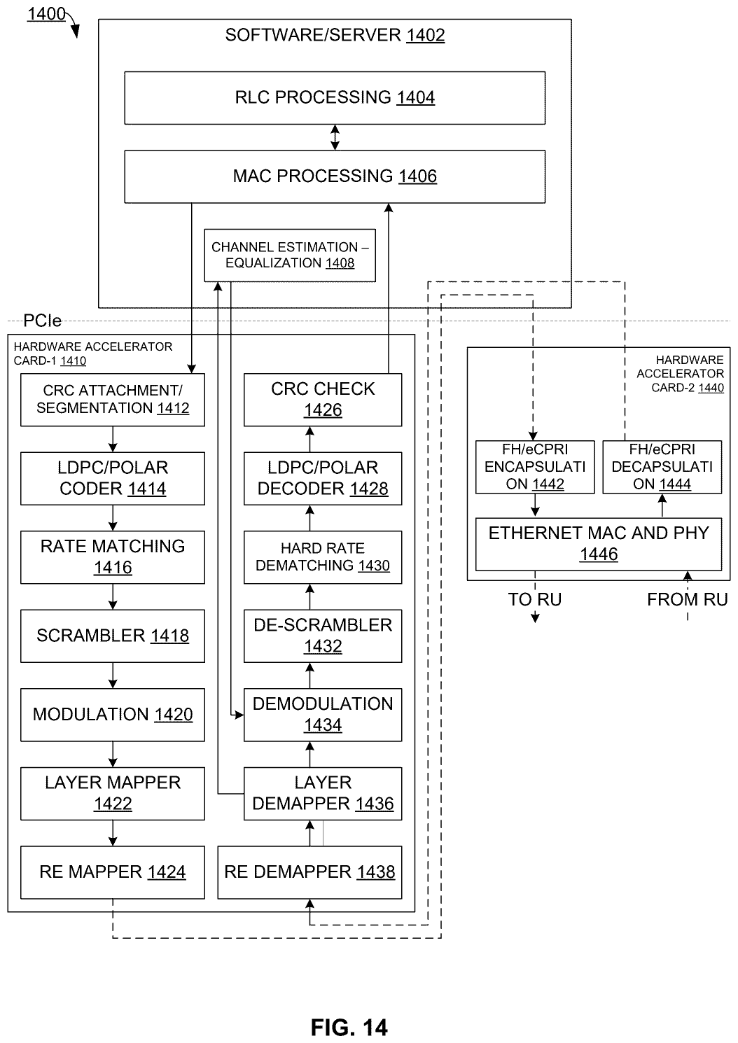

The first processing path in FIG. 13 has two accelerator cards, shown in FIG. 14. The second processing path can be similar to the example second processing paths described previously.

In the first processing path, as shown in FIG. 14, FH encapsulation/decapsulation and ethernet MAC and PHY can be implemented in a hardware device, for example a hardware accelerator card. L1 tasks and L2 tasks can be implemented in another hardware accelerator card, or other hardware device.

FIG. 14 illustrates another example processing flow 1400 of an O-DU with two accelerator cards in one processing path that can facilitate a wireless network device with multiple processing chains, in accordance with an embodiment of this disclosure. In some examples, part(s) of processing flow 1400 can be implemented by part(s) of system architecture 100 of FIG. 1 to facilitate a wireless network device with multiple processing chains.

Processing flow 1400 comprises software/server 1402, RLC processing 1404, MAC processing 1406, channel estimation—equalization 1408, hardware accelerator card-1 1410, CRC attachment/segmentation 1412, LDPC/polar coder 1414, rate matching 1416, scrambler 1418, modulation 1420, layer mapper 1422, RE mapper 1424, CRC check 1426, LDPC/polar decoder 1428, HARD rate dematching 1430, de-scrambler 1432, demodulation 1434, layer demapper 1436, RE demapper 1438, hardware accelerator card-2 1440, FH/eCPRI encapsulation 1442, FH/eCPRI decapsulation 1444, and ethernet MAC and PHY 1446.

On top of the architecture in FIG. 13, in FIG. 14, the first processing path has two accelerator cards. FH encapsulation/decapsulation and ethernet MAC and PHY can be implemented in a hardware accelerator card. L1 tasks, except CQI, channel estimation, timing estimation, and equalization, can be implemented in the other hardware accelerator card. L2 tasks and CQI, channel estimation, timing estimation, and equalization can be implemented in software/server.

The second processing path can be similar to the example second processing paths described previously.

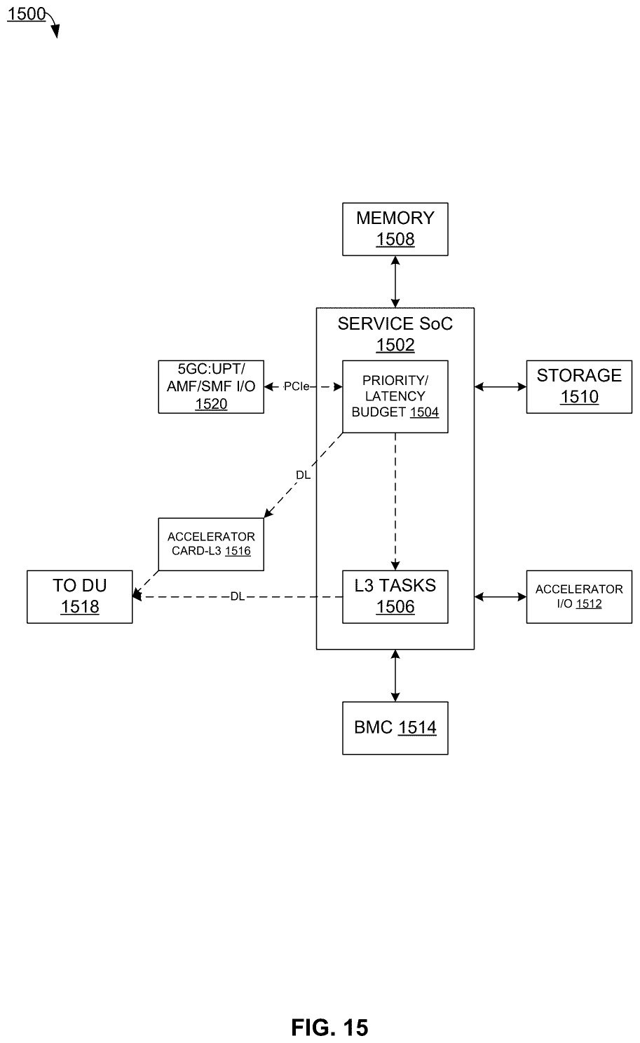

FIG. 15 illustrates an example system architecture 1500 of an O-CU that can facilitate a wireless network device with multiple processing chains, in accordance with an embodiment of this disclosure. In some examples, part(s) of system architecture 1500 can be implemented by part(s) of system architecture 100 of FIG. 1 to facilitate a wireless network device with multiple processing chains.

System architecture 1500 comprises service SoC 1502, priority/latency budget 1504, L3 tasks 1506, memory 1508, storage 1510, accelerator I/O 1512, BMC 1514, accelerator card-L3 1516, to DU 1518, and 5g core (5GC): user perceived throughput (UPT)/access and mobility management function (AMT)/session management function (SMF) I/O (5GC:UPT/AMF/SMF I/O) 1520.

In the first processing path, L3 tasks are implemented in hardware, for example a hardware accelerator card. In the second processing path, L3 tasks can be software implemented in a service SoC.

The CPU or host system in a O-DU can read/obtain, or refer to the priority/service indication, and/or latency budget of the packet from CU—for example the priority/service indication, and/or latency budget, can be added in a header of the packet from a CU, or defined headers can be reused for such purposes. The CPU or host system in the O-DU can instruct the packet to go through the first processing path if the priority indication is high, service indication is latency-sensitive/URLLC, latency budget is less than one threshold, or only one transmission is within the latency budget. Otherwise, the packet can go through the second processing path. In general, the packet can be processed through the path which has the lowest latency flow (for example more functions in hardware) for URLLC or latency sensitive 5QI related packets, and through alternate paths for lesser latency sensitive packets. The paths can be chosen based on the degree of latency requirements (PDB). Latency or PDB thresholds can be defined and used to select such processing flow choices.

Hardening these L3 tasks can reduce the corresponding processing time from around 100 s to 10 s, compared with software-implemented L3 tasks.

Where non-URLLC service does not have such strict processing time requirements, non-URLLC service can go through the second processing path: software based L3 tasks can be desired for latency-tolerance service.

L3 tasks can include service data adaptation protocol (SDAP) and packet data convergence protocol (PDCP) functions.

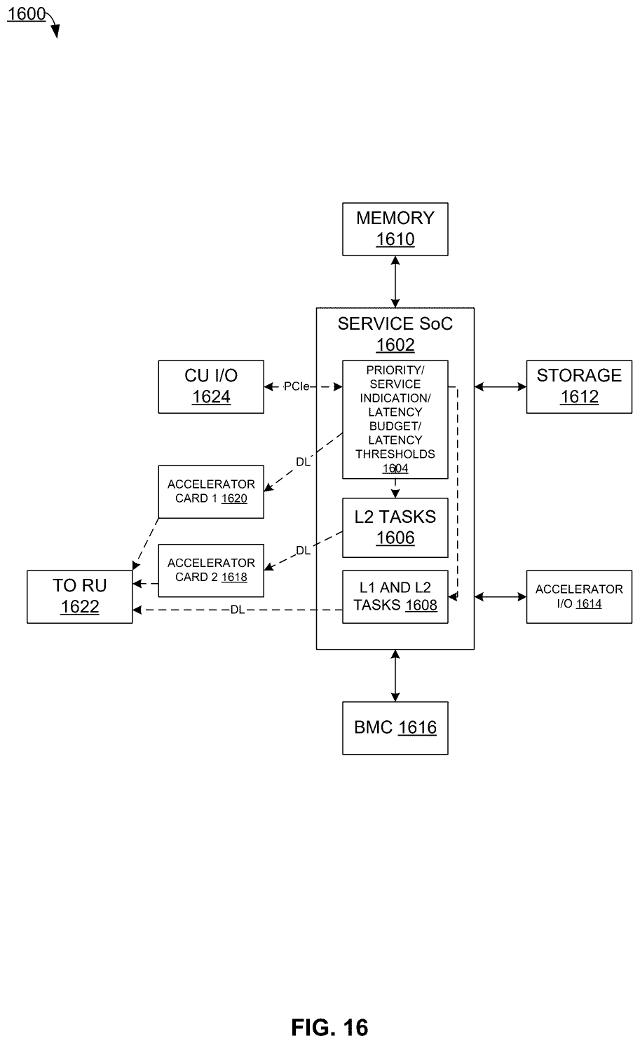

FIG. 16 illustrates an example system architecture 1600 of an O-DU with more than two processing paths that can facilitate a wireless network device with multiple processing chains, in accordance with an embodiment of this disclosure. In some examples, part(s) of system architecture 1600 can be implemented by part(s) of system architecture 100 of FIG. 1 to facilitate a wireless network device with multiple processing chains.

System architecture 1600 comprises service SoC 1602, priority/service indication/latency budget/latency thresholds 1604, L2 tasks 1606, L1 and L2 tasks 1608, memory 1610, storage 1612, accelerator I/O 1614, BMC 1616, accelerator card 2 1618, accelerator card 1 1620, to RU 1622, and CU I/O 1624.

In general, multiple such processing paths (more than two) with data processing functions computed over a combination of hardware and software compute platforms can be architected depending on needs of the latency requirements of the use cases.

Latency thresholds can be defined for overall use cases and based on the thresholds and latency requirements (PDB or other 5QI properties) of the packets. Different processing paths and/or combination of such paths can be used to process the different packets at the CU and DU.

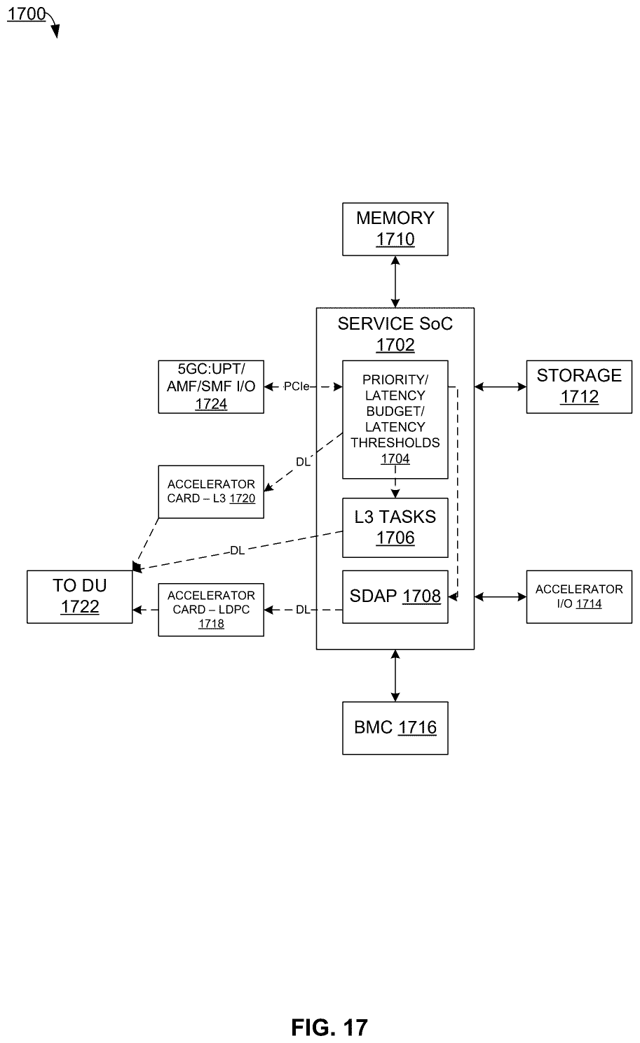

FIG. 17 illustrates an example system architecture 1700 of an O-CU with more than two processing paths that can facilitate a wireless network device with multiple processing chains, in accordance with an embodiment of this disclosure. In some examples, part(s) of system architecture 1700 can be implemented by part(s) of system architecture 100 of FIG. 1 to facilitate a wireless network device with multiple processing chains.

System architecture 1700 comprises service SoC 1702, priority/latency budget/latency thresholds 1704, L3 tasks 1706, service data adaptation protocol (SDAP) 1708, memory 1710, storage 1712, accelerator I/O 1714, BMC 1716, accelerator card—LDPC 1718, accelerator card—L3 1720, to DU 1722, and 5GC:UPT/AMF/SMF I/O 1724.

FIG. 18 illustrates another example system architecture 1800 for a wireless network device with multiple processing chains, in accordance with an embodiment of this disclosure. In some examples, part(s) of system architecture 1800 can be implemented by part(s) of system architecture 100 of FIG. 1 to facilitate a wireless network device with multiple processing chains.

System architecture 1800 comprises a first processing path through a radio access unit of the system, wherein the system is configured to conduct wireless communications with user equipment 1802; a second processing path through the radio access unit, wherein a first amount of time associated with processing via the first processing path is less than a second amount of time associated with processing via the second processing path 1804; and at least one processor, and at least one memory that stores executable instructions that, when executed by the at least one processor, facilitate performance of operations 1806. This can be a first path and second path as described herein.

In some examples, the radio access unit comprises a distributed unit, a centralized unit, or a base station.

In some examples, the first processing path is implemented in hardware, and wherein the second processing path is implemented in software. In some examples, the first processing path is implemented in hardware, and the hardware comprises a field programmable gate array, a digital signal processor, a hardware accelerator card, or a hardware accelerator chipset.

In some examples, the first amount of time associated with processing via the first processing path comprises a first maximum processing delay associated with the processing via the first processing path, and the second amount of time associated with processing via the second processing path comprises a second maximum processing delay associated with the processing via the second processing path.

In some examples, the first amount of time associated with processing via the first processing path comprises a first average processing delay associated with the processing via the first processing path, and the second amount of time associated with processing via the second processing path comprises a second average processing delay associated with the processing via the second processing path.

1808-1812 are various operations that can be performed via 1806.

Operation 1808 depicts, based on identifying data to process, selecting the first processing path as a selected processing path, or selecting the second processing path as the selected processing path. That is, a processing path can be selected for data.

In some examples, selecting the first processing path as a selected processing path is based on the data being associated with a priority value that satisfies a priority criterion.

Operation 1810 depicts processing the data with the selected processing path, to produce processed data. That is, the data can be processed with the selected processing path of operation 1808.

Operation 1812 depicts communicating the processed data with the user equipment as part of the wireless communications. That is, the processed data of operation 1810 can be communicated to a UE.

### Example Process Flows

FIG. 19 illustrates an example process flow 1900 for a wireless network device with multiple processing chains, in accordance with an embodiment of this disclosure. In some examples, one or more embodiments of process flow 1900 can be implemented by system architecture 100 of FIG. 1, or computing environment 2100 of FIG. 21.

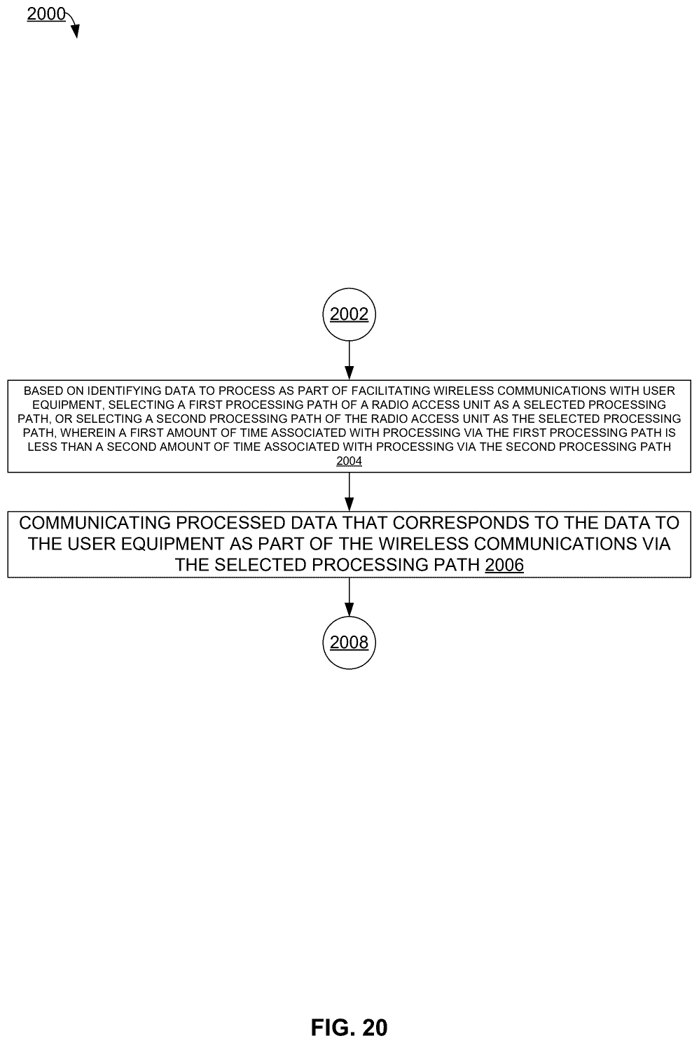

It can be appreciated that the operating procedures of process flow 1900 are example operating procedures, and that there can be embodiments that implement more or fewer operating procedures than are depicted, or that implement the depicted operating procedures in a different order than as depicted. In some examples, process flow 1900 can be implemented in conjunction with one or more embodiments of process flow 2000 of FIG. 20.

Process flow 1900 begins with 1902, and moves to operation 1904.

Operation 1904 depicts, based on identifying a data packet to process, selecting a first processing path of a radio access unit as a selected processing path, or selecting a second processing path of the radio access unit as the selected processing path, wherein a first amount of time associated with processing via the first processing path is less than a second amount of time associated with processing via the second processing path. In some examples, operation 1904 can be implemented in a similar manner as operation 1808 of FIG. 18.

In some examples, the selecting of the selected path is based on a priority indication associated with the data packet. In some examples, the selecting of the selected path is based on a service indication associated with the data packet. In some examples, the selecting of the selected path is based on a packet delay budget associated with the data packet.

After operation 1904, process flow 1900 moves to operation 1906.

Operation 1906 depicts processing the data packet with the selected processing path, to produce a processed data packet. In some examples, operation 1906 can be implemented in a similar manner as operation 1810 of FIG. 18.

After operation 1906, process flow 1900 moves to operation 1908.

Operation 1908 depicts communicating the processed data packet to a user equipment as part of the wireless communications. In some examples, operation 1908 can be implemented in a similar manner as operation 1812 of FIG. 18.

In some examples, the data packet is a first data packet, the selected processing path is a first selected processing path through a distributed unit of the radio access unit, and operation 1908 comprises, based on identifying a second data packet to process, selecting a third processing path of a centralized unit of the radio access unit as a second selected processing path, or selecting a fourth processing path of the centralized unit as the second selected processing path.

In some examples, operation 1908 comprises, based on a priority value associated with the data packet, processing the data packet with the selected processing path before processing another data packet that has already been selected to use the selected processing path.

In some examples, operation 1908 comprises, based on a priority value associated with the data packet, preempting processing another data packet other than the data packet that has already been selected to use the selected processing path as part of processing the data packet with the selected processing path.

After operation 1908, process flow 1900 moves to 1910, where process flow 1900 ends.

FIG. 20 illustrates an example process flow 2000 for a wireless network device with multiple processing chains, in accordance with an embodiment of this disclosure. In some examples, one or more embodiments of process flow 2000 can be implemented by system architecture 100 of FIG. 1, or computing environment 2100 of FIG. 21.

It can be appreciated that the operating procedures of process flow 2000 are example operating procedures, and that there can be embodiments that implement more or fewer operating procedures than are depicted, or that implement the depicted operating procedures in a different order than as depicted. In some examples, process flow 2000 can be implemented in conjunction with one or more embodiments of process flow 1900 of FIG. 19.

Process flow 2000 begins with 2002, and moves to operation 2004.

Operation 2004 depicts, based on identifying data to process as part of facilitating wireless communications with user equipment, selecting a first processing path of a radio access unit as a selected processing path, or selecting a second processing path of the radio access unit as the selected processing path, wherein a first amount of time associated with processing via the first processing path is less than a second amount of time associated with processing via the second processing path. In some examples, operation 2004 can be implemented in a similar manner as operation 1808 of FIG. 18.

In some examples, a priority value associated with the data indicates that the data is associated with an ultra-reliable and low latency communication process, and the selected processing path indicates the first processing path.

In some examples, the data is first data, the priority value is a first priority value, the selected processing path is a first selected processing path, and wherein operation 2004 comprises, selecting the second processing path for second data based on the second data being associated with a second priority value that the second data fails to be associated with the ultra-reliable and low latency communication process.

In some examples, a priority value associated with the data indicates that the data is associated with an ultra-reliable and low latency communication process, and selecting the first processing path as the selected processing path is based on a delay budget associated with the data satisfying a delay criterion.

In some examples, the data is first data, the priority value is a first priority value, the delay budget is a first delay budget, a second priority value associated with second data indicates that the second data is associated with the ultra-reliable and low latency communication process, and operation 2004 comprises selecting the second processing path for the second data based on a second delay budget associated with the second data failing to satisfy the delay criterion.

In some examples, the second processing path is implemented via a software-as-a-service platform.

After operation 2004, process flow 2000 moves to operation 2006.

Operation 2006 depicts communicating processed data that corresponds to the data to the user equipment as part of the wireless communications via the selected processing path. In some examples, operation 2006 can be implemented in a similar manner as operations 1810-1812 of FIG. 18.

After operation 2006, process flow 2000 moves to operation 2008, where process flow 2000 ends.

### Example Operating Environment

In order to provide additional context for various embodiments described herein, FIG. 21 and the following discussion are intended to provide a brief, general description of a suitable computing environment 2100 in which the various embodiments of the embodiment described herein can be implemented.

For example, parts of computing environment 2100 can be used to implement one or more embodiments of base station 102 and/or UEs 104 of FIG. 1.

In some examples, computing environment 2100 can implement one or more embodiments of the process flows of FIGS. 18-19 to facilitate a wireless network device with multiple processing chains.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 21, the example environment 2100 for implementing various embodiments described herein includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi-processor architectures can also be employed as the processing unit 2104.

The system bus 2108 can be any of several types of bus structure that can further interconnect to a memory bus (with or without a memory controller), a peripheral bus, and a local bus using any of a variety of commercially available bus architectures. The system memory 2106 includes ROM 2110 and RAM 2112. A basic input/output system (BIOS) can be stored in a nonvolatile storage such as ROM, erasable programmable read only memory (EPROM), EEPROM, which BIOS contains the basic routines that help to transfer information between elements within the computer 2102, such as during startup. The RAM 2112 can also include a high-speed RAM such as static RAM for caching data.

The computer 2102 further includes an internal hard disk drive (HDD) 2114 (e.g., EIDE, SATA), one or more external storage devices 2116 (e.g., a magnetic floppy disk drive (FDD) 2116, a memory stick or flash drive reader, a memory card reader, etc.) and an optical disk drive 2120 (e.g., which can read or write from a CD-ROM disc, a DVD, a BD, etc.). While the internal HDD 2114 is illustrated as located within the computer 2102, the internal HDD 2114 can also be configured for external use in a suitable chassis (not shown). Additionally, while not shown in environment 2100, a solid state drive (SSD) could be used in addition to, or in place of, an HDD 2114. The HDD 2114, external storage device(s) 2116 and optical disk drive 2120 can be connected to the system bus 2108 by an HDD interface 2124, an external storage interface 2126 and an optical drive interface 2128, respectively. The interface 2124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. The systems and methods described herein can be implemented utilizing various commercially available operating systems or combinations of operating systems.

Computer 2102 can optionally comprise emulation technologies. For example, a hypervisor (not shown) or other intermediary can emulate a hardware environment for operating system 2130, and the emulated hardware can optionally be different from the hardware illustrated in FIG. 21. In such an embodiment, operating system 2130 can comprise one virtual machine (VM) of multiple VMs hosted at computer 2102. Furthermore, operating system 2130 can provide runtime environments, such as the Java runtime environment or the .NET framework, for applications 2132. Runtime environments are consistent execution environments that allow applications 2132 to run on any operating system that includes the runtime environment. Similarly, operating system 2130 can support containers, and applications 2132 can be in the form of containers, which are lightweight, standalone, executable packages of software that include, e.g., code, runtime, system tools, system libraries and settings for an application.

Further, computer 2102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 2102, e.g., applied at the application execution level or at the operating system (OS) kernel level, thereby enabling security at any level of code execution.

A user can enter commands and information into the computer 2102 through one or more wired/wireless input devices, e.g., a keyboard 2138, a touch screen 2140, and a pointing device, such as a mouse 2142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2104 through an input device interface 2144 that can be coupled to the system bus 2108, but can be connected by other interfaces, such as a parallel port, an IEEE 1394 serial port, a game port, a USB port, an IR interface, a BLUETOOTH® interface, etc.

A monitor 2146 or other type of display device can be also connected to the system bus 2108 via an interface, such as a video adapter 2148. In addition to the monitor 2146, a computer typically includes other peripheral output devices (not shown), such as speakers, printers, etc.

The computer 2102 can operate in a networked environment using logical connections via wired and/or wireless communications to one or more remote computers, such as a remote computer(s) 2150. The remote computer(s) 2150 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2152 is illustrated. The logical connections depicted include wired/wireless connectivity to a local area network (LAN) 2154 and/or larger networks, e.g., a wide area network (WAN) 2156. Such LAN and WAN networking environments are commonplace in offices and companies, and facilitate enterprise-wide computer networks, such as intranets, all of which can connect to a global communications network, e.g., the Internet.

When used in a LAN networking environment, the computer 2102 can be connected to the local network 2154 through a wired and/or wireless communication network interface or adapter 2158. The adapter 2158 can facilitate wired or wireless communication to the LAN 2154, which can also include a wireless access point (AP) disposed thereon for communicating with the adapter 2158 in a wireless mode.

When used in a WAN networking environment, the computer 2102 can include a modem 2160 or can be connected to a communications server on the WAN 2156 via other means for establishing communications over the WAN 2156, such as by way of the Internet. The modem 2160, which can be internal or external and a wired or wireless device, can be connected to the system bus 2108 via the input device interface 2144. In a networked environment, program modules depicted relative to the computer 2102 or portions thereof, can be stored in the remote memory/storage device 2152. It will be appreciated that the network connections shown are examples, and other means of establishing a communications link between the computers can be used.

When used in either a LAN or WAN networking environment, the computer 2102 can access cloud storage systems or other network-based storage systems in addition to, or in place of, external storage devices 2116 as described above. Generally, a connection between the computer 2102 and a cloud storage system can be established over a LAN 2154 or WAN 2156 e.g., by the adapter 2158 or modem 2160, respectively. Upon connecting the computer 2102 to an associated cloud storage system, the external storage interface 2126 can, with the aid of the adapter 2158 and/or modem 2160, manage storage provided by the cloud storage system as it would other types of external storage. For instance, the external storage interface 2116 can be configured to provide access to cloud storage sources as if those sources were physically connected to the computer 2102.

The computer 2102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a first processing path through a radio access unit of the system, wherein the system is configured to conduct wireless communications with user equipment;
a second processing path through the radio access unit, wherein a first amount of time associated with processing via the first processing path is less than a second amount of time associated with processing via the second processing path;
at least one processor; and
at least one memory that stores executable instructions that, when executed by the at least one processor, facilitate performance of operations, comprising:
based on identifying data to process,
selecting the first processing path as a selected processing path, or
selecting the second processing path as the selected processing path;
processing the data with the selected processing path, to produce processed data; and
communicating the processed data with the user equipment as part of the wireless communications.

2. The system of claim 1, wherein the radio access unit comprises a distributed unit, a centralized unit, or a base station.

3. The system of claim 1, wherein selecting the first processing path as a selected processing path is based on the data being associated with a priority value that satisfies a priority criterion.

4. The system of claim 1, wherein the first processing path is implemented in hardware, and wherein the second processing path is implemented in software.

5. The system of claim 1, wherein the first processing path is implemented in hardware, and wherein the hardware comprises a field programmable gate array, a digital signal processor, a hardware accelerator card, or a hardware accelerator chipset.

6. The system of claim 1, wherein the first amount of time associated with processing via the first processing path comprises a first maximum processing delay associated with the processing via the first processing path, and wherein the second amount of time associated with processing via the second processing path comprises a second maximum processing delay associated with the processing via the second processing path.

7. The system of claim 1, wherein the first amount of time associated with processing via the first processing path comprises a first average processing delay associated with the processing via the first processing path, and wherein the second amount of time associated with processing via the second processing path comprises a second average processing delay associated with the processing via the second processing path.

8. A method, comprising:
based on identifying a data packet to process,
selecting, by a system comprising at least one processor that is configured to facilitate wireless communications with user equipment, a first processing path of a radio access unit as a selected processing path, or
selecting, by the system, a second processing path of the radio access unit as the selected processing path, wherein a first amount of time associated with processing via the first processing path is less than a second amount of time associated with processing via the second processing path;
processing, by the system, the data packet with the selected processing path, to produce a processed data packet; and
communicating, by the system, the processed data packet to the user equipment as part of the wireless communications.

9. The method of claim 8, wherein the data packet is a first data packet, wherein the selected processing path is a first selected processing path through a distributed unit of the radio access unit, and wherein the operations further comprise:
based on identifying a second data packet to process,
selecting, by the system, a third processing path of a centralized unit of the radio access unit as a second selected processing path, or
selecting, by the system, a fourth processing path of the centralized unit as the second selected processing path.

10. The method of claim 8, wherein the selecting of the selected path is based on a priority indication associated with the data packet.

11. The method of claim 8, wherein the selecting of the selected path is based on a service indication associated with the data packet.

12. The method of claim 8, wherein the selecting of the selected path is based on a packet delay budget associated with the data packet.

13. The method of claim 8, further comprising:
based on a priority value associated with the data packet, processing, by the system, the data packet with the selected processing path before processing another data packet that has already been selected to use the selected processing path.

14. The method of claim 8, further comprising:
based on a priority value associated with the data packet, preempting processing another data packet other than the data packet that has already been selected to use the selected processing path as part of processing the data packet with the selected processing path.

15. A non-transitory computer-readable medium comprising instructions that, in response to execution, cause a system comprising at least one processor to perform operations, comprising:
based on identifying data to process as part of facilitating wireless communication with user equipment,
selecting a first processing path of a radio access unit as a selected processing path, or
selecting a second processing path of the radio access unit as the selected processing path, wherein a first amount of time associated with processing via the first processing path is less than a second amount of time associated with processing via the second processing path; and
communicating processed data that corresponds to the data to the user equipment as part of the wireless communications via the selected processing path.

16. The non-transitory computer-readable medium of claim 15, wherein a priority value associated with the data indicates that the data is associated with an ultra-reliable and low latency communication process, and wherein the selected processing path indicates the first processing path.

17. The non-transitory computer-readable medium of claim 16, wherein the data is first data, wherein the priority value is a first priority value, wherein the selected processing path is a first selected processing path, and wherein the operations further comprise:
selecting the second processing path for second data based on the second data being associated with a second priority value that the second data fails to be associated with the ultra-reliable and low latency communication process.

18. The non-transitory computer-readable medium of claim 15, wherein a priority value associated with the data indicates that the data is associated with an ultra-reliable and low latency communication process, and wherein selecting the first processing path as the selected processing path is based on a delay budget associated with the data satisfying a delay criterion.

19. The non-transitory computer-readable medium of claim 18, wherein the data is first data, wherein the priority value is a first priority value, wherein the delay budget is a first delay budget, wherein a second priority value associated with second data indicates that the second data is associated with the ultra-reliable and low latency communication process, and wherein the operations further comprise:
selecting the second processing path for the second data based on a second delay budget associated with the second data failing to satisfy the delay criterion.

20. The non-transitory computer-readable medium of claim 15, wherein the second processing path is implemented via a software in a service platform.
